(19) United States
(12) Patent Application Publication
(10) Pub. No.: US 2004/0004099 A1
(43) Pub. Date: Jan. 8, 2004

(54) Motorcycle lifting device and carrier rack assembly

(76) Inventor: Samuel Wesley Crouch, Boulder, CO (US)

Correspondence Address: Emery L. Tracy, P.O. Box 1518, Boulder, CO, 80306-1518, US

(21) Appl. No.: 10/612,868

(22) Filed: Jul. 2, 2003

Related U.S. Application Data
(60) Provisional application No. 60/393,592, filed on Jul. 3, 2002.

(51) Int. Cl. B60R 9/00; B60R 11/00

(52) U.S. Cl. 224/499; 224/504; 224/519

(57) ABSTRACT

A motorcycle lifting device and carrier rack assembly for lifting and carrying a motorcycle on a vehicle is provided. The vehicle has a receiver hitch. The assembly comprises a carrier rail secured to the receiver hitch and alternatingly movable from a stowed position to a deployed position with the carrier rail receiving the motorcycle. A lifting and lowering mechanism lifts the carrier rail from the deployed position to the stowed position and lowers the carrier rail from the deployed position to the stowed position wherein the carrier rail remains substantially parallel to the ground in both the stowed position and the deployed position and during lifting and lowering of the carrier rail.

The present application is a continuation and claims priority of pending U.S. provisional patent application Serial No. 60/393,592, filed on Jul. 3, 2002, entitled “Motorcycle Lift and Carrying Device”.

### BACKGROUND OF THE INVENTION

1. Field of the Invention

This invention relates generally to a motorcycle lifting device and carrier rack assembly and, more particularly, the invention relates to a motorcycle lifting device and carrier rack assembly to a vehicle for lifting and carrying the motorcycle between desired locations.

2. Description of the Prior Art

A variety of carrier racks have been devised for attachment to a vehicle for carrying articles. These conventional racks are designed to provide added cargo space, and generally, are quite small and constructed of light weight material, therefore, not suitable for carrying heavy loads.

Some conventional carrier racks attempt to overcome the above disadvantages with designs which engage the hauling vehicle at multiple locations. For instance, some carrier racks mount via inverted U-shaped bolts to the rear axle of the hauling vehicle at two spaced apart positions. In addition, the carrier is further braced to the upper portion of the vehicle. Such attachment to the rear axle may not be feasible for modem automobiles and the attachment method is also undesirable because the carrier rack cannot be interchangeably mounted to other hauling vehicles. A carrier rack designed for attachment to a conventional hitch would be more desirable.

Another carrier rack employs three mounting bars for attachment to a conventional hitch assembly. The center bar is received into the conventional hitch receiver opening and the other two side mounting bars are bolted to the hitch assembly. This attachment method achieves the goal of lessening the side to side movement of the carrier rack during transit, but it is inconvenient to use. For attachment and removal of the carrier rack, an operator has to crawl under the hauling vehicle to unscrew the bolts. In addition, this design unnecessarily weakens the hitch assembly by creating apertures in the hitch assembly to receive the attachment bolts. Furthermore, the carrier rack is not structured to carry a heavy load.

Another type of a motorcycle carrier rack includes is the tilt lift type carrier rack. The tilt lift type carrier rack has a platform with one end pivoting to the ground and the platform maintaining an angle with the ground. The motorcycle is then pushed or driven onto the tilted platform. Once the motorcycle reaches a certain point on the platform, the platform typically automatically pivots back to its substantially horizontal position due to the weight of the motorcycle. Unfortunately, these types of lifts are difficult to use, dangerous for the person(s) loading and unloading the motorcycle, and require strenuous amounts of energy when pushing the motorcycle onto the tilted platform.

Motorcycle jacks or lifts are also known in the art. These devices are typically stand-alone devices used to elevate the motorcycle. In one case, there is a hydraulic lift but does not include a rail for receiving a motorcycle. Unfortunately, none of the conventional devices combine a motorcycle lift with a carrier rack to maneuver the motorcycle into the proper position on the vehicle.

Accordingly, there exists a need for a motorcycle lifting device and carrier rack assembly which can be securely and removably mounted to a conventional hitch assembly and which permits easy loading, unloading and transporting of a motorcycle or other heavy load. Additionally, a need exists for a motorcycle lifting device and carrier rack assembly which combines a lifting mechanism with a carrier rack. Furthermore, there exists a need for a motorcycle lifting device and carrier rack assembly which combines ease of use, safety, storage, lower cost, and faster on-loading/off-loading. Further yet, a need exists for a motorcycle lifting device and carrier rack assembly which allows a user to open his or her trunk lid with the motorcycle stowed thereon.

### SUMMARY

The present invention is a motorcycle lifting device and carrier rack assembly for lifting and carrying a motorcycle on a vehicle. The vehicle has a receiver hitch. The assembly comprises a carrier rail secured to the receiver hitch and alternatingly movable from a stowed position to a deployed position with the carrier rail receiving the motorcycle. A lifting and lowering mechanism lifts the carrier rail from the deployed position to the stowed position and lowers the carrier rail from the deployed position to the stowed position wherein the carrier rail remains substantially parallel to the ground in both the stowed position and the deployed position and during lifting and lowering of the carrier rail.

In addition, the present invention includes a portable motorcycle carrier for carrying a motorcycle on a vehicle. The carrier comprises a mounting frame releasably secured to the vehicle and a lift mechanism secured to the mounting frame. A carrier rail receives the motorcycle and is movable between a deployed position and a stowed position. Connection means are secured between the carrier rail and the lift mechanism for maintaining the carrier rail in a substantially horizontal position when deployed, stowed, and at any position therebetween. Securement means on the carrier rail releasably secure the motorcycle to the carrier rail.

The present invention further includes a method for lifting and carrying a motorcycle on a vehicle. The method comprises securing a carrier rail to the vehicle, lowering the carrier rail from a stowed position adjacent the vehicle to a deployed position adjacent the ground, maintaining the carrier rail in a substantially horizontal position in the stowed position, in the deployed position, and during lowering from the stowed position to the deployed position, loading the motorcycle on the carrier rail, lifting the carrier rail from the deployed position to the stowed position, and maintaining the carrier rail in a substantially horizontal position during lifting from the deployed position to the stowed position.

### BRIEF DESCRIPTION OF THE DRAWINGS

FIG. 1 is a perspective view illustrating a motorcycle lifting device and carrier rack assembly, constructed in accordance with the present invention, with the lifting device and carrier rack assembly positioned in the stowed or up position;

FIG. 2 is a perspective view illustrating the motorcycle lifting device and carrier rack assembly of FIG. 1, constructed in accordance with the present invention, with the lifting device and carrier rack assembly positioned in the deployed or down position;

FIG. 3 is a perspective view illustrating the motorcycle lifting device and carrier device of FIG. 1, constructed in accordance with the present invention, with the lifting device and carrier rack assembly being positioned in the stowed position with carrier arms and a carrier rail folded for transportation without a motorcycle loaded;

FIG. 4 is a perspective view illustrating a foot peg over center pull down device of the motorcycle lifting device and carrier device of FIG. 1, constructed in accordance with the present invention; and

FIG. 5 is a perspective view illustrating another portion of the front wheel chock mechanism of the motorcycle lifting device and carrier device of FIG. 1, constructed in accordance with the present invention.

### DETAILED DESCRIPTION OF THE PREFERRED EMBODIMENTS

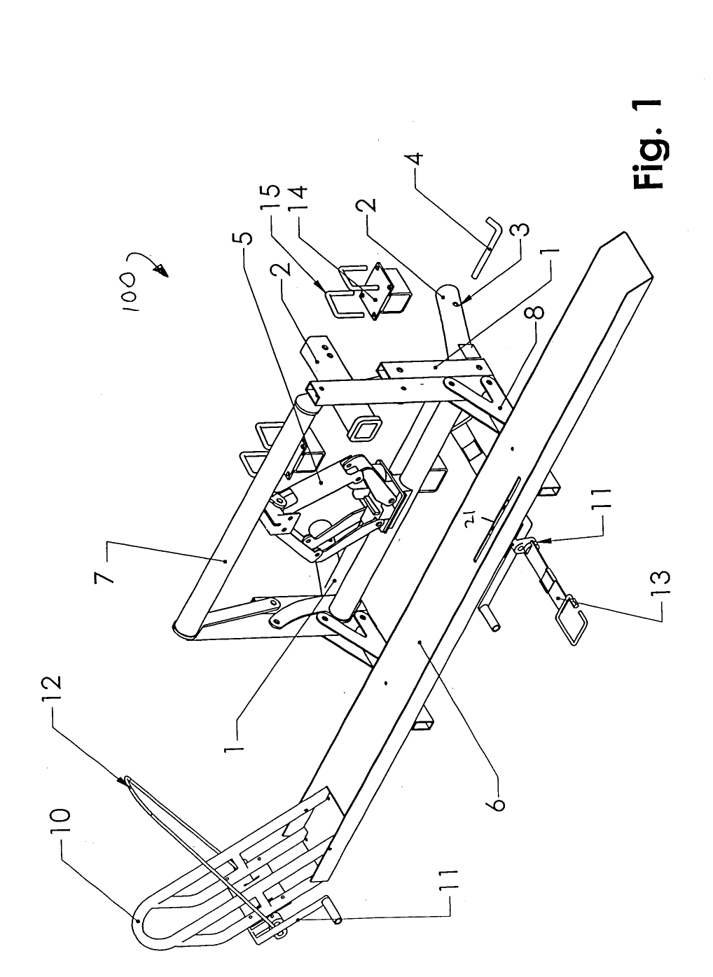

As illustrated in FIG. 1, the present invention is a motorcycle lifting device and carrier rack assembly, indicated generally at 100, for lifting and carrying a motorcycle on an automobile or other vehicle (not shown). While the present invention has been and will be described for lifting and carrying a motorcycle, it is within the scope of the present invention to use the motorcycle lifting device and carrier rack assembly 100 for other vehicles, articles, etc.

As illustrated in FIG. 1, the lifting device and carrier rack assembly 100 of the present invention is positioned in the stowed or up position. The lifting device and carrier rack assembly 100 includes a support bar 1 for attaching the assembly 100 to a receiver hitch frame (not shown) which is typically mounted to the rear of the vehicle. The support bar 1 includes mounting tubes 2 which slide into brackets 14 that are mounted on the receiver hitch frame. The mounting brackets 14 are preferably fastened to the receiver hitch by U-bolts 15 allowing adjustment of the position of the mounting brackets 14 along the receiver hitch frame. Safety pins 4 or other fastening means are inserted through mounting tube holes 3 aligned with corresponding holes in the receiver hitch brackets 14. A jack or other lifting mechanism 5 raises and lowers the carrier rail 6 via a carrier rack chassis 7 having carrier arms 8 supporting the carrier rail 6.

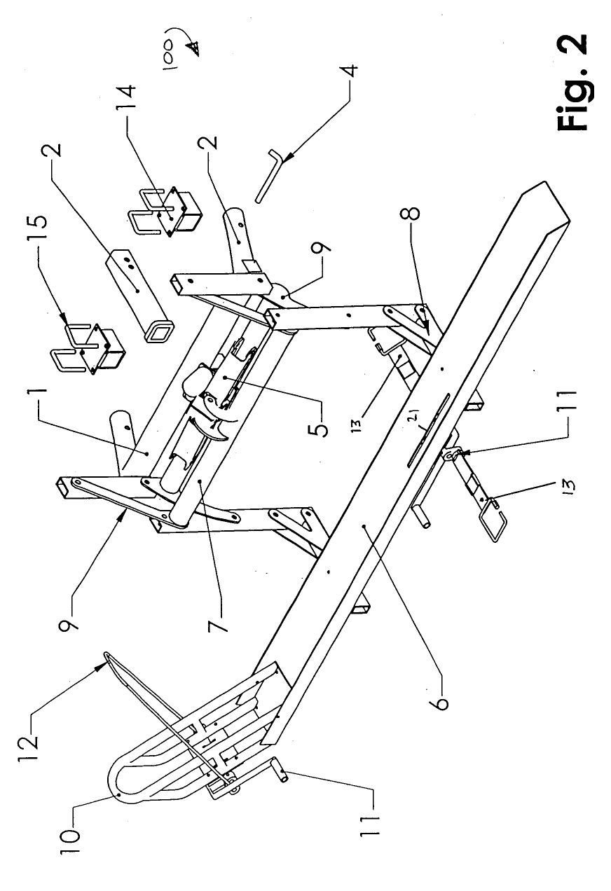

As illustrated in FIG. 2, the lifting device and carrier rack assembly 100 is illustrated in the deployed (down) position with the jack 5 collapsed. Note that the jack 5 has maintained a substantially vertical position by rotating with the carrier rack chassis 7 during the movement thereby allowing most of the jack 5 forces to be applied in the direction desired. Link arms 9 stabilize the carrier rack chassis 7 during this motion maintaining the carrier rack chassis 7 in a substantially perpendicular relation to the ground.

The lifting device and carrier rack assembly 100 further includes a wheel chock 10 attached to the carrier rail 6 and for holding the motorcycle in a substantially vertical position while the user positions the pull down rod 12 over the top of the front motorcycle wheel and attaches the pull down straps 13 to the motorcycle foot pegs of the motorcycle. An over-center actuator 11 cooperating with the pull down rod 12 and an over-center actuator 11 cooperating with the pull down straps 13 secure the motorcycle to the carrier rail 6. Since different motorcycles have different size tires (typically ranging between eighteen (18″) inches and twenty-one (21″) inches), the pull down rod 12 is threadably adjustable for receiving various-sized tires.

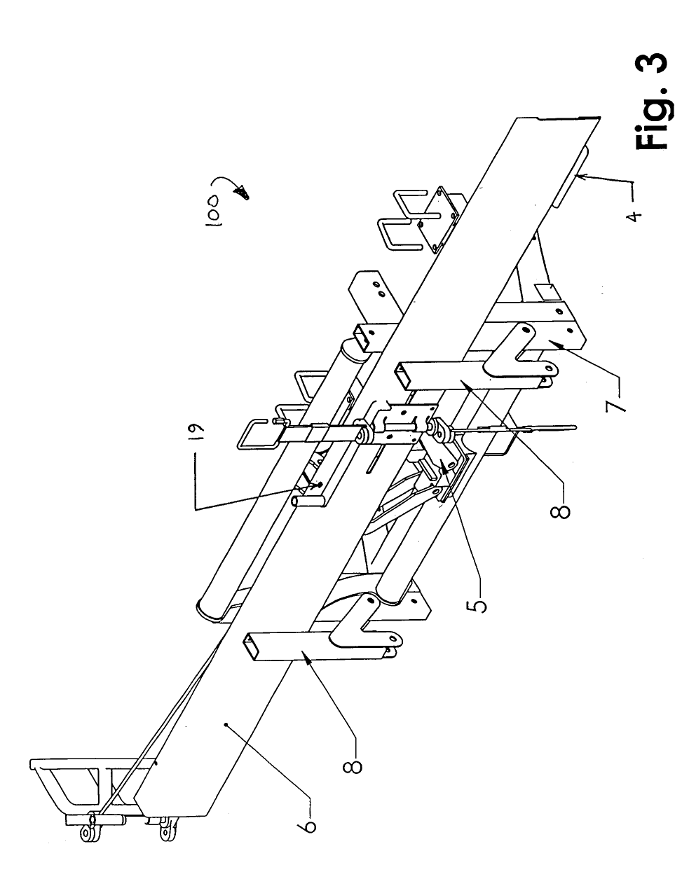

As illustrated in FIG. 3, the lifting device and carrier rack assembly 100 is in the stowed position with the carrier arms 8 along with the carrier rail 6 folded up for transportation without a motorcycle loaded. The carrier rack pins 4 have been removed to facilitate this reposition. A carrier rack lock pin 4 is placed through a hole 19 that aligns to secure the carrier rail 6 in this position.

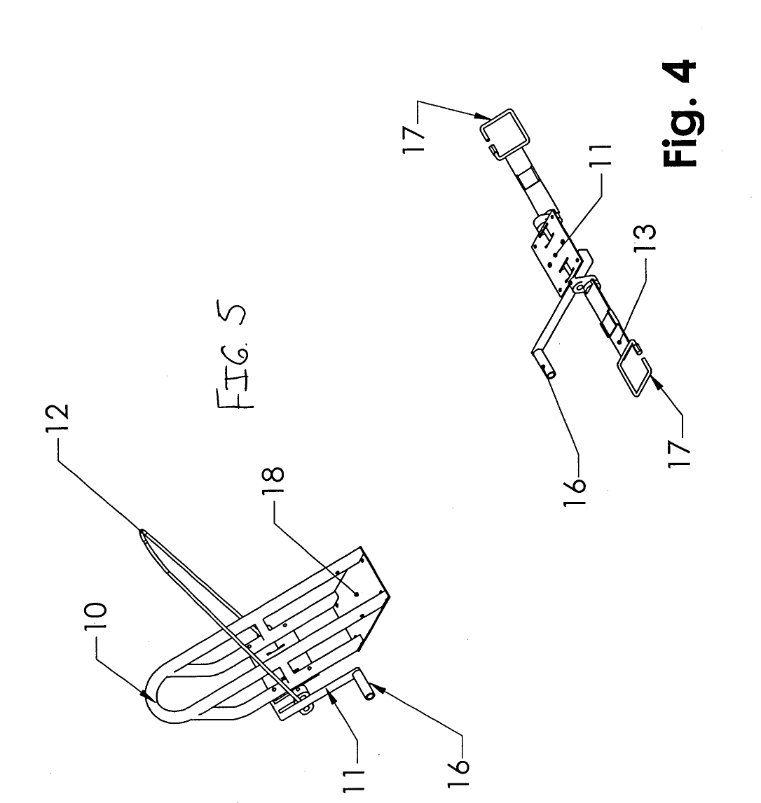

FIG. 4 illustrates the foot peg over center pull down with the pull down straps 13 to fit the motorcycle foot pegs. The position of the foot peg over center pull down is adjustable along the carrier rail 6 to accommodate various-sized motorcycles. The adjustability is preferably accomplished by a pin (not shown) traveling along a slot 21. Means for tightening the screw within the slot 19 are also provided.

FIG. 5 illustrates the front wheel chock mechanism 10 of the lifting device and carrier rack assembly 100. The front wheel chock mechanism 10 comprises a frame 20 into which the motorcycle wheel fits and is locked into place by a pull down rod 12 which is actuated by a over-the-center crank 11 by the user cranking on the handle 16. A center locking device 11 is used secure the motorcycle by lifting straps 13 with eyelets 17 placed on the motor cycle frame or foot pegs and then actuating crank handle 16 causing an over-the-center action pulling the motorcycle in a general downward direction.

Preferably, the lifting device and carrier rack assembly 100 is constructed from a metal material including, but not limited to steel, aluminum, etc. It is within the scope of the present invention, however, to construct the lifting device and carrier rack assembly 100 from other materials including, but not limited to, plastic, resin, etc., so long as the selected material has sufficient strength to support a motorcycle mounted thereon.

Operation

In operation, the motorcycle lift device and carrier rack assembly 100 of the present invention is simple and efficient requiring less cost and allowing more convenience than other conventional methods of transporting a motorcycle. Five effects are provided by this invention:

(1) ease of use;

(2) safety;

(3) storage;

(4) lower cost; and

(5) faster on-loading/off-loading.

(1) By lowering the carrier rack 7 to the ground, the user has little or no difficulty in loading the motorcycle. The work required to lift the motorcycle is accomplished by actuating the jack handle which requires minimal strength by the user.

(2) Because the user accomplishes the work while standing on the ground with the motorcycle, accidental damage to the motorcycle and the user is minimized. Other systems use ramps that require the motorcycle to be at an elevated position during the loading allowing the motorcycle to fall over. Furthermore, the carrier rail 6 is preferably positioned pointing the curb such that the motorcycle can be loaded from the side away from traffic rather than from the rear.

(3) Because the motorcycle lifting device and carrier rack assembly 100 of the present invention is easily attached and removed to a standard receiver tow hitch, and it is light and compact, the user is able to store the device easily. Unlike trailers that take up storage space or must be parked on the street, the motorcycle lifting device and carrier rack assembly 100 can be stored in a garage or shed requiring little space.

(4) The motorcycle lifting device and carrier rack assembly 100 of the present invention is lower in cost than a trailer and does not require license or storage fees. Additionally, little or no maintenance is required as compared to a (conventional trailer, i.e., tires, wheel bearings, light bulbs, etc.

(4) Because of the ease of operation of the jack 5 and no requirement of ramps, the motorcycle lifting device and carrier rack assembly 100 of the present invention can be used to load a motorcycle, lift up, and drive away in less than approximately five (5) minutes.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A motorcycle lifting device and carrier rack assembly for lifting and carrying a motorcycle on a vehicle, the vehicle having a receiver hitch, the lifting device and carrier rack assembly comprising:
an elongated carrier rail secured to the receiver hitch and alternatingly movable from a stowed position to a deployed position, the carrier rail receiving the motorcycle; and
lifting and lowering means for lifting the carrier rail from the deployed position to the stowed position and lowering the carrier rail from the deployed position to the stowed position;
wherein the carrier rail remains substantially parallel to the ground in both the stowed position and the deployed position and during lifting and lowering of the carrier rail.

2. The assembly of claim 1, and further comprising:
brackets mounted to the receiver hitch;
adjustable U-bolts for securing the brackets to the receiver hitch;
a cross bar;
mounting tubes secured to the cross bar and slidable into the brackets; and
safety pins insertable through the mounting tube into the brackets.

3. The assembly of claim 1 wherein the lifting and lowering means maintains a substantially vertical position during lifting and lowering thereby allowing the jack forces to be applied in a desired direction.

4. The assembly of claim 1 wherein the carrier rail has a first end and a second end, and further comprising:
a wheel chock for receiving the wheel of the motorcycle;
a pull down rod positioned over the wheel chock and positionable over the tire;
an over-center actuator cooperating with the pull down rod for securing the pull down rod over the tire of the motorcycle.

5. The assembly of claim 4 wherein the carrier rail has a first side wall and a second side wall, the first and second side walls extending from the first end of the carrier rail to the second end of the carrier rail, the wheel chock being positioned between the first side wall and the second side wall.

6. The assembly of claim 1, and further comprising:
pull down strap for receiving the foot pegs of the motorcycle; and
an over-center actuator cooperating with the pull down strap for securing the motorcycle.

7. The assembly of claim 6 wherein the position of the pull down strap and the over-center actuator is adjustable along at least a portion of the carrier rail.

8. The assembly of claim 1 wherein the carrier rail is rotatable to a position substantially perpendicular to the ground when in the stowed position.

9. A portable motorcycle carrier for carrying a motorcycle on a vehicle, the carrier comprising:
a mounting frame releasably secured to the vehicle;
a lift mechanism secured to the mounting frame;
a carrier rail for receiving the motorcycle and movable between a deployed position and a stowed position;
connection means secured between the carrier rail and the lift mechanism for maintaining the carrier rail in a substantially horizontal position when deployed, stowed, and at any position therebetween; and
securement means on the carrier rail for releasably securing the motorcycle to the carrier rail.

10. The carrier of claim 9 wherein the connection means is a carrier rack chassis having carrier arms supporting the carrier rail.

11. The carrier of claim 9 wherein the lift mechanism maintains a substantially vertical position during lifting and lowering thereby allowing the jack forces to be applied in a desired direction.

12. The carrier of claim 9 wherein the carrier rail has a first end and a second end, and further comprising:
a wheel chock for receiving the wheel of the motorcycle;
a pull down rod positioned over the wheel chock and positionable over the tire; and
an over-center actuator for securing the pull down rod over the tire of the motorcycle.

13. The carrier of claim 8, and further comprising:
pull down strap for receiving the foot pegs of the motorcycle; and
an over-center actuator cooperating with the pull down strap for securing the motorcycle.

14. The carrier of claim 13 wherein the position of the pull down strap and the over-center actuator is adjustable along at least a portion of the carrier rail.

15. The carrier of claim 8 wherein the carrier rail is rotatable to a position substantially perpendicular to the ground when in the stowed position.

16. A method for lifting and carrying a motorcycle on a vehicle, the method comprising:
securing a carrier rail to the vehicle;
lowering the carrier rail from a stowed position adjacent the vehicle to a deployed position adjacent the ground;
maintaining the carrier rail in a substantially horizontal position in the stowed position, in the deployed position, and during lowering from the stowed position to the deployed position;
loading the motorcycle on the carrier rail from a position on the side of the vehicle;
lifting the carrier rail from the deployed position to the stowed position; and
maintaining the carrier rail in a substantially horizontal position during lifting from the deployed position to the stowed position.

17. The method of claim 16, and further comprising:
providing lifting and lowering means; and
maintaining the lifting and lowering means in a substantially vertical position during lifting and lowering thereby allowing the jack forces to be applied in a desired direction.

18. The method of claim 16 wherein the carrier rail has a first end and a second end, and further comprising:
securing a wheel chock to the carrier rail for receiving the wheel of the motorcycle;
positioning a pull down rod over the wheel chock; and
securing the pull down rod over the tire of the motorcycle.

19. The method of claim 16, and further comprising:
providing a pull down strap for receiving the foot pegs of the motorcycle; and
adjusting the position of the pull down strap; and
securing the pull down strap.

20. The method of claim 16, and further comprising:
rotating the carrier rail to a position substantially perpendicular to the ground when in the stowed position.
